(19) United States
(12) Patent Application Publication
(10) Pub. No.: US 2015/0111019 A1
(43) Pub. Date: Apr. 23, 2015

(54) ELECTRET NANOFIBROUS WEB

(71) Applicant: E I DU PONT DE NEMOURS AND COMPANY, Wilmington, DE (US)

(72) Inventors: TAO HUANG, Downingtown, PA (US); Gelnn Creighton Catlin, Newark, DE (US); Jay J. Croft, Middletown, DE (US); Thomas Patrick Daly, Aston, PA (US); Zachary R. Dilworth, Wilmington, DE (US); Thomas William Harding, Wilmington, DE (US); Vindhya Mishra, Wilmington, PA (US); Carl Saquing, Newark, DE (US); Wai-Shing Yung, Chadds Ford, PA (US)

(21) Appl. No.: 14/519,255

(22) Filed: Oct. 21, 2014

Related U.S. Application Data
(60) Provisional application No. 61/893,321, filed on Oct. 21, 2013.

(51) Int. Cl. D04H 1/4291; B01D 39/08; D04H 1/724; D01D 5/08; D04H 1/435

(52) U.S. Cl. CPC D04H 1/4291; D01D 5/08; D04H 1/435; D04H 1/724; B01D 39/083; D10B 2331/04; D10B 2321/021; D10B 2321/022; D10B 2401/10; D10B 2401/00
USPC 428/219; 264/8; 442/414; 442/340; 442/401

(57) ABSTRACT

The present invention is directed toward an electret nanofibrous web comprising a single source randomly intermingled fiber network with a range of fiber diameters that yields improved mechanical strength.

This application claims the benefit of priority of U.S. Provisional Application No. 61/893,321 filed Oct. 21, 2013, which is incorporated herein by reference in it's entirety.

### FIELD OF THE INVENTION

The present invention is directed toward an electret nanofibrous web comprising a single source randomly intermingled fiber network with a range of fiber diameters that yields improved mechanical strength.

### BACKGROUND

The increased surface to volume ratio afforded by nanofibers has significant influences on a broad range of applications. In particular, in filter performance, which is based on producing the highest flow rate while trapping and retaining the finest particles without blocking the filter, nanofibers have improved interception and inertial impaction efficiencies and result in slip flow at the fiber surface, affording better performance at a given pressure drop. Consequently, nanofibers as a coating layer on substrate or laminated with a substrate are currently incorporated into filters in air, liquid and automotive applications.

Polymer nanofibers can be produced from solution-based electrospinning or electroblowing process; however they have very high processing cost, limited throughputs and low productivity. Melt blowing nanofiber processes that randomly lay down fibers do not provide adequate uniformity at sufficiently high throughputs for most end use applications. The resulting nanofibers are often laid on substrate layer of coarse fiber nonwoven or microfiber nonwoven to construct multiple layers. A problem with melt-blown nanofibers or small microfibers, exposed on the top of the web, they are very fragile and easily crushed by normal handling or contact with some object. Also, the multilayer nature of such webs increases their thickness and weight, and also introduces some complexity in manufacture.

On the other hand, electrically-charged nonwoven webs are commonly used as filters in respirators to protect the wearer from inhaling airborne contaminants. The electric charge enhances the ability of the nonwoven web to capture particles that are suspended in a fluid. The nonwoven web captures the particles as the fluid passes through the web. Electrically-charged dielectric articles are often referred to as “electrets”, and a variety of techniques have been developed over the years for producing these products. Fibrous electret webs have been produced by electrizing the fibers or the fiber webs, or deliberately post-charging them with a corona discharge device (U.S. Pat. No. 4,588,537, U.S. Pat. No. 6,365,088, U.S. Pat. No. 6,969,484); or tribocharging which occurs when high-velocity uncharged jets of gases or liquids are passed over the surface of a dielectric film (U.S. Pat. No. 5,280,406), or adding certain additives to the web to improve the performance of electrets.

U.S. Pat. No. 8,277,711 disclosed a nozzle-less centrifugal melt spin process. The resulting nanofibers were laid on a belt collector to form web media using the process of WO 2013/096672.

What is needed is a single layer nanofibrous web which has permanently electrostatic charge and is strong enough for handling in making the end-use articles or devices.

### SUMMARY

The present invention is directed toward an electret nanofibrous web comprising a single source randomly intermingled fiber network, wherein the electret nanofibrous web has an electrostatic charge of at least −8.0 kV, and a web strength of at least 2.0 gf/cm/gsm.

The present invention is further directed toward an electret nanofibrous web comprising: (a) at least about 65% by number of fibers in the electret nanofibrous web are nanofibers with a number average diameter less than about 1000 nm; and (b) at most about 30% by number of fibers in the electret nanofibrous web are microfibers with a number average diameter from about 1.0 μm to about 3.0 μm; and (c) at most about 5% by number of fibers in the electret nanofibrous web are coarse fibers with a number average diameter greater than about 3.0 μm.

The present invention is still further directed toward an electret nanofibrous web made by a centrifugal melt spinning process.

### BRIEF DESCRIPTION OF THE FIGURES

FIG. 1 is an illustration of web structure of the present invention.

FIG. 2 is a view of a centrifugal fiber spinning apparatus using spin disk suitable for use in laying fibrous web according to WO2013096672 and the present invention.

FIG. 3 is a view of a centrifugal fiber spinning apparatus using spin bowl suitable for use in laying fibrous web according to the present invention.

FIG. 4 is an illustration of the fiber spinning pattern from centrifugal film fibrillation according to the present invention.

FIG. 5A is an illustration of the fiber formation from instability of the thin film according to the present invention. FIG. 5B is an illustration of the fibers formed from instability of the thin film according to the present invention.

FIG. 6 is an illustration of the fiber spinning pattern according to U.S. Pat. No. 8,277,711.

FIG. 7 is an illustration of the fiber spinning pattern from blowing film fibrillation according to the present invention.

FIG. 8A shows the stretching zone temperature for polypropylene spinning using a rotating spin disk. FIG. 8A shows the stretching zone temperature for polypropylene spinning using a rotating spin bowl. FIG. 8C shows thermally stimulated current of polypropylene fine fibers as a function of temperature.

FIGS. 9A, 9B, 9C and 9D are SEM images at 5,000×, 2,500×, 1,000× and 250× magnifications of Example 1 of the present invention.

FIGS. 10A, 10B, 100 and 10D are SEM images of Comparative Examples 1-4, respectively.

FIG. 11 is a chart of web strength verses web elongation comparing Example 1 in the present invention and the Comparative Example 1 of purely nanofiber web according to U.S. Pat. No. 8,277,711. The nanofibrous web of Example 1 in the present invention has better strength and elongation properties.

FIG. 12 shows the pore size distribution of Example.

FIG. 13 shows the pore size distribution comparing Example 1 in the present invention and the Comparative Example 1 of pure nanofiber web according to U.S. Pat. No. 8,277,711.

FIG. 14 shows the pore size distribution comparing the Comparative Example 4 of melt-blown nanofiber web and the Comparative Example 5 of melt-blown microfiber web.

### DETAILED DESCRIPTION

### Definitions

The term “web” as used herein refers to layer of a network of fibers commonly made into a nonwoven.

The term “nonwoven” as used herein refers to a web of a multitude of essentially randomly oriented fibers where no overall repeating structure can be discerned by the naked eye in the arrangement of fibers. The fibers can be bonded to each other, or can be unbounded and entangled to impart strength and integrity to the web. The fibers can be staple fibers or continuous fibers, and can comprise a single material or a multitude of materials, either as a combination of different fibers or as a combination of similar fibers each comprising of different materials.

The term “nanofibrous web” as used herein refers to a web constructed predominantly of nanofibers. “Predominantly” means that greater than 50% of the fibers in the web are nanofibers.

The term “nanofibers” as used herein refers to fibers having a number average diameter less than about 1000 nm. In the case of non-round cross-sectional nanofibers, the term “diameter” as used herein refers to the greatest cross-sectional dimension.

The term “microfibers” as used herein refers to fibers having a number average diameter from about 1.0 μm to about 3.0 μm.

The term “coarse fibers” as used herein refers to fibers having a number average diameter greater than about 3.0 μm.

The term “coarse-grade nanofibrous web” as used herein refers to the nanofibrous web having the mean flow pore size greater than about 5.0 μm.

The term “electrets” as used herein refers to electrically-charged dielectric articles.

The term “stand-alone” as used herein refers to the nanofibrous web is a single layer, self-contained and without any substrate.

The term “single source” as used herein refers to any structural properties and electrically-charged property of the web that come from a single spinning process.

The term “centrifugal spinning process” as used herein refers to any process in which fibers are formed by ejection from a rotating member.

The term “rotating member” as used herein refers to a spinning device that propels or distributes a material from which fibrils or fibers are formed by centrifugal force, whether or not another means such as air is used to aid in such propulsion.

The term “concave” as used herein refers to an inner surface of a rotating member that can be curved in cross-section, such as hemispherical, have the cross-section of an ellipse, a hyperbola, a parabola or can be frustoconical, or the like.

The term “spin disk” as used herein refers to a rotating member that has a disk shape with a concave, frustoconical or flat open inner surface.

The term “spin bowl” as used herein refers to a rotating member that has a bowl shape with a concave or frustoconical open inner surface.

The term “fibril” as used herein refers to an elongated structure that may be formed as a precursor to fine fibers that form when the fibrils are attenuated. Fibrils are formed at a discharge point of the rotating member. The discharge point may be an edge, serrations or an orifice through which fluid is extruded to form fibers.

The term “nozzle-free” as used herein refers to the fibril or fibers that are not from a nozzle-type spinning orifices, or there are no any nozzles on rotating member.

The term “air flow field” as used herein refers to a vector field that describes the air speed and direction at any point or physical location in the process of the invention.

The term “charged” as used herein refers to an object in the process that has a net electric charge, positive or negative polarity, relative to uncharged objects or those objects with no net electric charge.

The term “spinning fluid” as used herein refers to a thermoplastic polymer in either melt or solution form that is able to flow and be formed into fibers.

The term “discharge point” as used herein refers to a location on a spinning member from which fibrils or fibers are ejected. The discharge point may, for example, be an edge, or an orifice through which fibrils are extruded.

The term “essentially” as used herein refers to that if a parameter is held “essentially” at a certain value, then changes in the numerical value that describes the parameter away from that value that do not affect the functioning of the invention are to be considered within the scope of the description of the parameter.

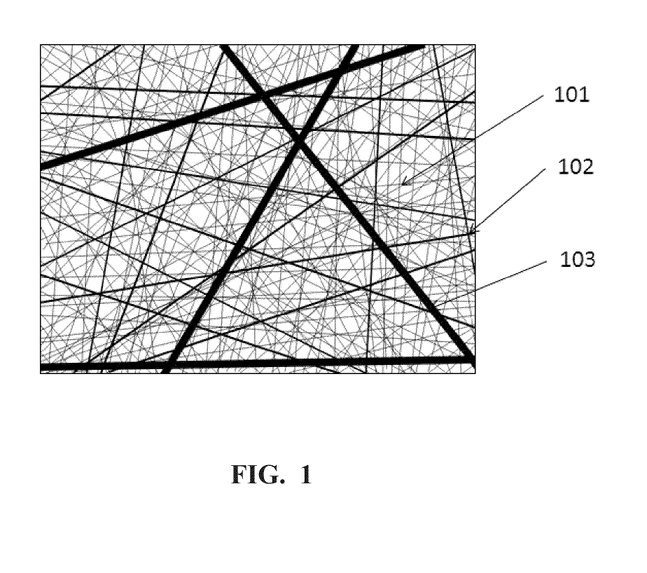

The present invention is directed toward an electret nanofibrous nonwoven web as the selective barrier medium with improved balance of high flow and barrier properties comprising a single layer polymeric nonwoven web, wherein the nonwoven web comprises a single source of randomly intermingled fiber network. The network comprises at least about 65% by number of fibers in the nanofibrous web are nanofibers with an average fiber diameter less than about 1000 nm, at most about 30% by number of fibers in the nanofibrous web are microfibers with an average fiber diameter from about 1.0 μm to about 3.0 μm, and at most about 5% by number of fibers in the nanofibrous web are coarse fibers with an average fiber diameter greater than about 3.0 μm, and wherein the average fiber diameter of the nanofibrous web is less than about 1.0 μm. As shown in FIG. 1, the majorities of fibers are nanofibers, as shown as 101, with small percentage of microfibers, as shown as 102, and an even smaller percentage of coarse fibers, as shown as 103, in the web structure.

In principle, the nanofibrous web can be made using the centrifugal melt spinning process as disclosed in U.S. Pat. No. 8,277,711. Uniform thin film fibrillation produces nanofiber formation. The melt flow spread on the inner surface of the spin disk forms a thin film. The film fibrillation occurs at the edge of spinning disk and forms thin threads. These thin threads are further stretched into fibers by centrifugal force. For a given polymer, nanofibers are formed from a uniform stable thin film fibrillation in U.S. Pat. No. 8,277,711. The operation parameters of fiber spinning are temperatures, melt feeding rate and disk rotating speed. In the present invention, changing the operation regime of temperatures, melt feeding rate and disk rotating speed creates filming instability with the relative thicker film moving outward with radial banding from the center to the edge and the film appears wavy in thickness. The nanofibers are formed from the thinner region of thin film, the coarse fibers are from the thicker region of the thin film, and the microfibers are from the film region in between. This process utilizes a spinning disk or bowl that generates fibers with a range of fiber diameters.

The present invention relates to the changes of operation on temperatures, melt feeding rate and disk rotating speed to create the filming instability and the relative thicker wavy film.

For a given polymer comparing with U.S. Pat. No. 8,277,711, the present invention has lower temperature of the inner surface of spin disk or spin bowl, melt extrusion and melt transfer line temperature, as well as the stretching zone temperature as described in the Examples. For example, the pure nanofiber web in Comparative Example 1 is made according to U.S. Pat. No. 8,277,711, where the temperature of inner surface of spin disk or spin bowl is 260° C., melt extrusion and melt transfer line temperature are 200° C., as well as the stretching zone temperature is 150° C. The nanofibrous web comprising of nanofibers, microfibers and coarse fibers in Example 1 is made according to the present invention, where the temperature of inner surface of spin disk or spin bowl is 200° C., melt extrusion and melt transfer line temperature are 200° C., as well as the stretching zone temperature is 100° C.

For a given polymer comparing with U.S. Pat. No. 8,277,711, the present invention is about lowering the rotating speed of spin disk or spin bowl as described in the Examples. For example, the purely nanofiber web in Comparative Example 1 is made according to U.S. Pat. No. 8,277,711, where the rotating speed is 14,000 rpm, The nanofibrous web comprising nanofibers, microfibers and coarse fibers in Example 1 is made according to the present invention, where the rotating speed is 10,000 rpm.

For a given polymer comparing with U.S. Pat. No. 8,277,711, the present invention is about to increasing the melt feeding rate to the spin disk or spin bowl as described in the Examples. For example, the pure nanofiber web in Comparative Example 1 is made according to U.S. Pat. No. 8,277,711, where the melt feeding rate is 8 gram/min, the nanofibrous web comprising of nanofibers, microfibers and coarse fibers in Example 1 is made according to the present invention, where the melt feeding rate is 18.14 gram/min.

The present invention concerns processing higher polymer melt viscosity (melt viscosity 1,000 cP to about 100,000 cP equates to 1 Pa·S to about 100 Pa·S) of U.S. Pat. No. 8,277,711. In Example 6, polypropylene blends of 50% of Marlex HGX 3:50 and 50% of Metocene MF 650Y, the zero shear viscosity is 131.86 Pa·S at 200° C. In Example 8, polyethylene terephthalate (Eastman PET F61), the zero shear viscosity is 163.38 Pa·S at 270° C.

The present invention is also about applying controlled pulse feeding. The present invention is also about applying controlled pulse rotating speed.

The fibers were laid on a belt collector to form PP web media using the process of WO 2013/096672, which is hereby incorporated by reference. The web laydown of fibers is controlled by a combination of the designed air flow field and a charging arrangement. The operation parameters of air flow field are the air temperatures and air flow rates of the stretching zone air, shaping air and a center air applied through the hollow rotating shaft and an anti-swirling hub. There is dual high voltage charging on the collector belt and an on the corona ring around the spinning disk. The finished product of nanofibrous web has maintained an electrostatic charge. The resulting nanofibrous web has the enhanced mechanical properties compared with the pure nanofiber web. The as-spun nanofibrous nanofibrous web in the present invention has a porosity of at least about 80%, a mean flow pore size of at most about 15 μm, and a Frazier air permeability from about 10 cm³/cm²/min to about 1000 cm³/cm²/min at 125 Pa. The nanofibrous web has a basis weight of between about 5 to about 120 g/m² and preferably between about 20 g/m² to about 60 g/m².

### Methods of Spinning

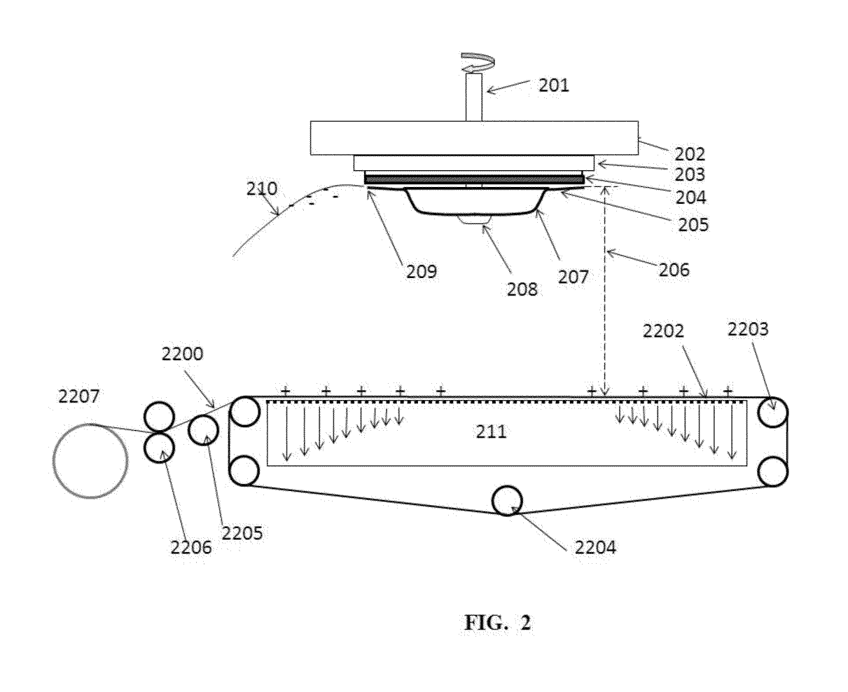

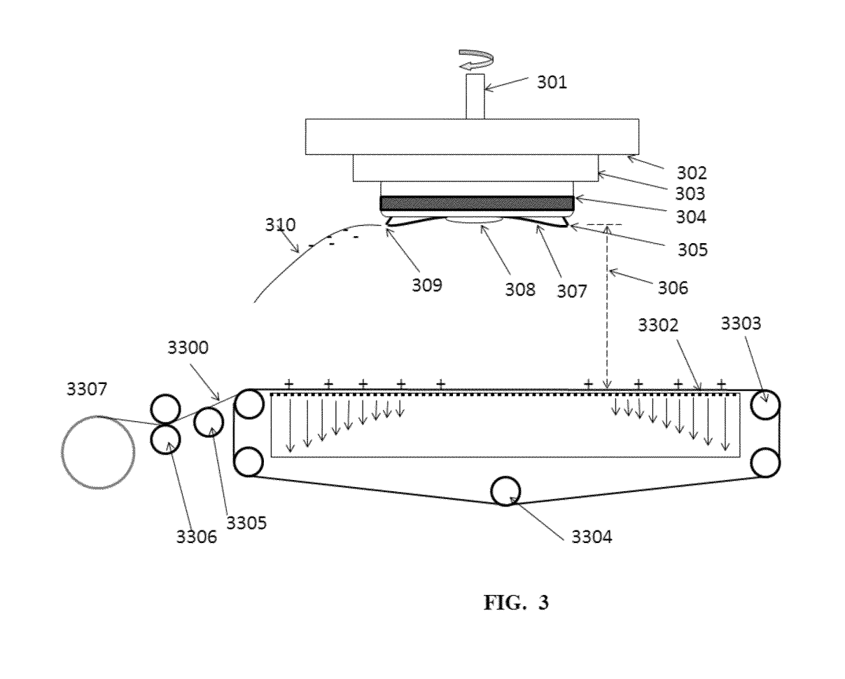

Considering first FIG. 2 for spin disk and FIG. 3 for spin bowl, fibers 210 or 310 are shown exiting a discharge point 209 at the edge of spin disk or 309 at the edge of spin bowl. The fibers are deposited on a collector 211 or 311. Typically, fibers do not flow in a controlled fashion towards the collector and do not deposit evenly on the collector, as illustrated schematically in FIG. 2 or FIG. 3. The process of WO 2013/096672 used in the present invention remedies this situation by applying air and electrostatic charge to fibrils and fibers being ejected from a rotating member, with the objective of producing a particularly uniform web.

In one embodiment, the rotating member is a spinning disk or a spinning bowl, but is not limited to such and any member that has an edge or an orifice (“discharge point”) from which fibers can be discharged. The process may then comprise the steps of supplying a spinning melt or solution of at least one thermoplastic polymer to an inner spinning surface of a heated rotating distribution disc, cup, or other device having a forward surface fiber discharge point. The spinning melt or solution (“spinning fluid”) is distributed along the inner spinning surface so as to distribute the spinning melt into a thin film and toward the discharge point. The process may further comprise a discharging step that consists essentially of discharging continuous separate molten polymer fibrous streams from the forward surface discharge point and then such fibrous streams or fibrils are attenuated by centrifugal force to produce polymeric fibers.

In a further embodiment the discharged fibrous stream may be attenuated by an air flow directed with a component radially away from the discharge point.

It will be understood by one skilled in the art that other means of generating the fibers from a rotating member can be used. For example the rotating member may have holes or orifices through which the polymer melt or solution is discharged. The rotating member can be in the form of a cup, or a flat or angled disk. The fibrils or fibers formed from the rotating member may be attenuated by air, centrifugal force, electrical charge, or a combination thereof.

FIG. 2 and FIG. 3 schematically illustrate apparatus that can be used to practice an embodiment of the invention. A spin pack comprises a rotating hollow shaft 201 or 301 for driving a spin disk 205 or a spin bowl 305. A fiber stretching zone air heating ring 203 or 303 with a perforate air exit plate 204 or 304 is assembled around the spin disk or spin bowl. A shaping air ring 202 or 302 is mounted above the stretching zone air ring and passes air vertically downwards in the orientation of FIG. 2 or FIG. 3 in order to direct fiber towards the collector 211 or 311. A charged ring with needle assembly 204 or 304 is placed inside of stretching zone air heating ring 203 or 303 in order to charge the fiber stream 210 or 310. An air hub 208 or 308 is mounted below the spin disk 205 or 305 on the rotating shaft 201 or 301. A desired fiber stream 210 or 310 of umbrella shape carrying electric charge is formed by the air flow field from the combination of the air from the gap of spin disk and its heater, the stretching zone air, the shaping air and the air flow from the rotating air hub.

The fibers were laid on a belt collector to form nanofibrous nanofibrous web using the process of WO 2013/096672, which is hereby incorporated by reference. A vacuum box web laydown collector 211 or 311 may be placed under the whole spin pack. The spin pack to collector distance 206 may be in a range of 10 cm 15 cm. The collector may have a perforate surface. Vacuum is applied to collector with the highest vacuum strength at the corners and the edges of the collector and the vacuum strength gradually reduce moving away from the corners and the edges of the collector to the center of the collector where the vacuum strength is zero. The result stand-alone web is 2200 In FIGS. 2 and 3300 in FIG. 3. The fibers were collected on a circling belt 2202 or 3202, driven by 2203 or 3303, 2204 or 3304 is a tension adjusting roll, 2205 or 3305 is a supporting roll for the stand-alone nanofibrous web, the stand-alone web is through a pair of nips and a wind-up roll, 2207 or 3307, and is taken up.

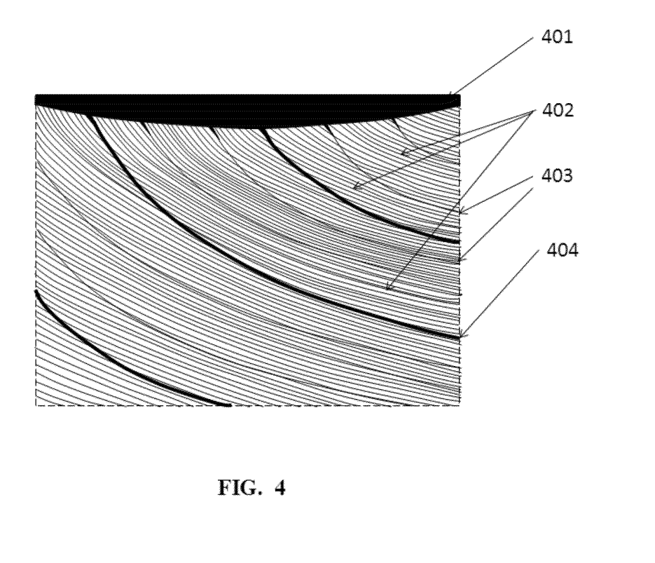

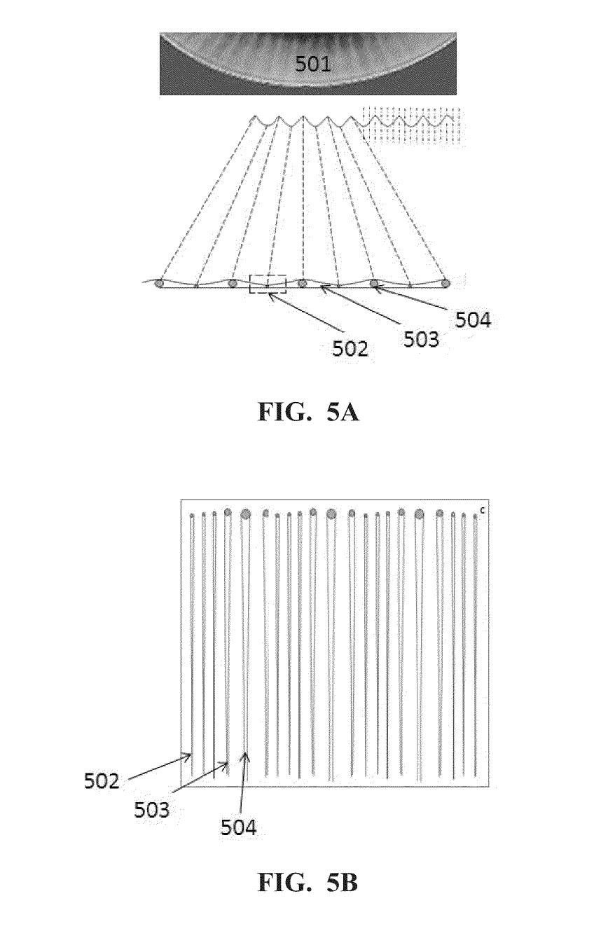

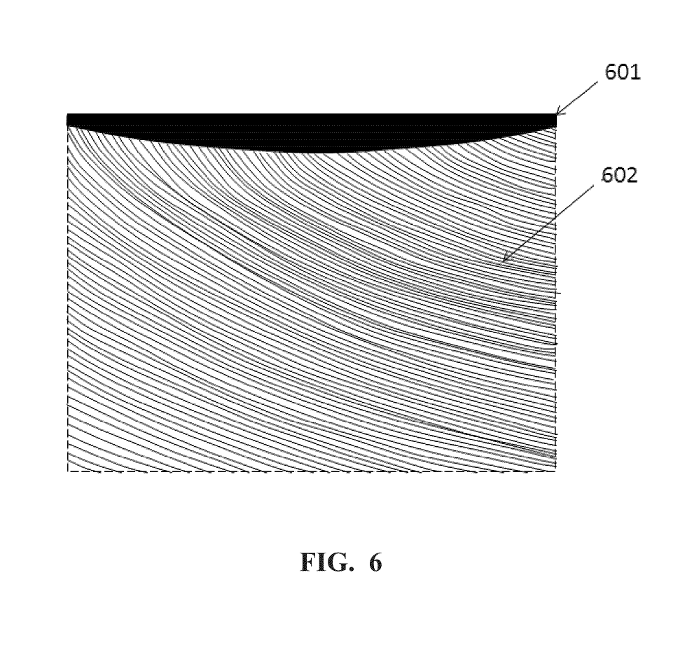

FIG. 4 illustrates the fiber pattern that can be used to implement the process of the invention and this is obtained with the implementation of FIG. 2 or FIG. 3. Due to the filming instability, the thin film moves outward with radial banding from the center to the edge, and the film appears wavy in thickness as shown as 501 in FIG. 5. The nanofibers as shown as 402 in FIG. 4 or 502 in FIGS. 5A and 5B are formed from the thinner region of thin film, the coarse fibers as shown 404 in FIG. 4 or 504 in FIGS. 5A and 5B are from the thick region of the film, and the microfibers as shown as 403 in FIG. 4 or 503 in FIGS. 5A and 5B are from the film region in between. FIG. 6 illustrates the fiber pattern that can be used to implement the process of U.S. Pat. No. 8,277,711 to make pure nanofiber web. The nanofiber stream 602 is formed at the edge of the spin disk 601.

FIG. 7 illustrates an alternative process of film blowing possibly to make the similar web structure, where the polymer melt can be issued to a filming blade 700, a pair of blowing air knives 701 is placed around the filming blade 700. Due to the filming instability, the thin film moves outward with downward banding from the top to the edge of the filming blade 700, and the film appears wavy in thickness. The nanofibers as shown as 702 in FIG. 7 are formed from the thinner region of thin film, the coarse fibers as shown as 704 in FIG. 7 are from the thick region of the film and the microfibers as shown as 703 in FIG. 7 are from the film region in between.

Fibers may be spun from any of the thermoplastic resins capable of using in centrifugal fiber or nanofiber spinning. These include polar polymers, such as polyesters, polyethylene terephthalate (PET), polybutylene terephthalate (PBT), and polytrimethyl terephthalate (PTT), and polyamides like nylon, suitable non-polar polymers include polypropylene (PP), polybutylene (PB), polyethylene (PE), poly-4-methylpentene (PMP), and their copolymers (including EVA copolymer), polystyrenepolymethylmethacrylate (PMMA), polytrifluorochloroethylene, polyurethanes, polycarbonates, silicones, and blends of these.

### Methods of Charging

Any high voltage direct current (d.c.) or alternating current (a.c.) source may be used to supply the electrostatic field of the invention. The electric field is used to supply a charge to the spinning fluid. Spinning fluid may be charged while on the rotating member, or as it is discharged in the form of fibrils or fibers, or even after fibers have been formed as a result of attenuation by air or an electrostatic field. The spinning fluid may be charged directly, such as by means of an ion current from a corona discharge produced by a charged entity proximate to the rotating member. One example of such a charged entity would be a ring concentric with the rotating member and located proximate to the molten polymer or polymer solution or to the fibrils or fibers as they are discharged.

The spinning fluid, fibrils or nanofibers may even be charged by induction from a charge held on or near the collector.

The current drawn in the charging process is expected to be small (preferably less than 10 mA). The source should have variable voltage settings (e.g. 0 kV to 80 kV), preferably −5 kV to −15 kV for corona ring and +50 to +70 kV for collection plate, and preferably (−) and (+) polarity settings to permit adjustments in establishing the electrostatic field.

The nanofibers are therefore charged in the process of the invention relative to a collector, such that an electric field is present between the fibers and the collector. The collector may be grounded or charged directly or indirectly via a charged plate or other entity in its vicinity, for example below it relative to the rotating member.

The nanofibers may attain their charge by the application of a charge to the polymer melt, the molten or solution fibrils, the nanofibers, or any combination of these three locations.

The nanofibers may be charged directly, such as by means of a corona discharge and resulting ion current caused by a charged entity proximate to the fibers. One example of such a charged entity would be a ring concentric with the rotating member and located proximate to the molten polymer or polymer solution or to the fibrils or fibers as they are discharged.

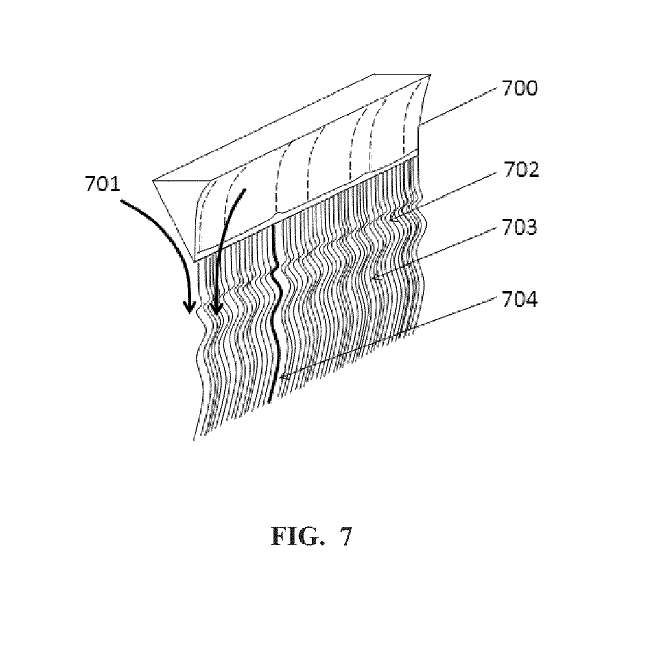

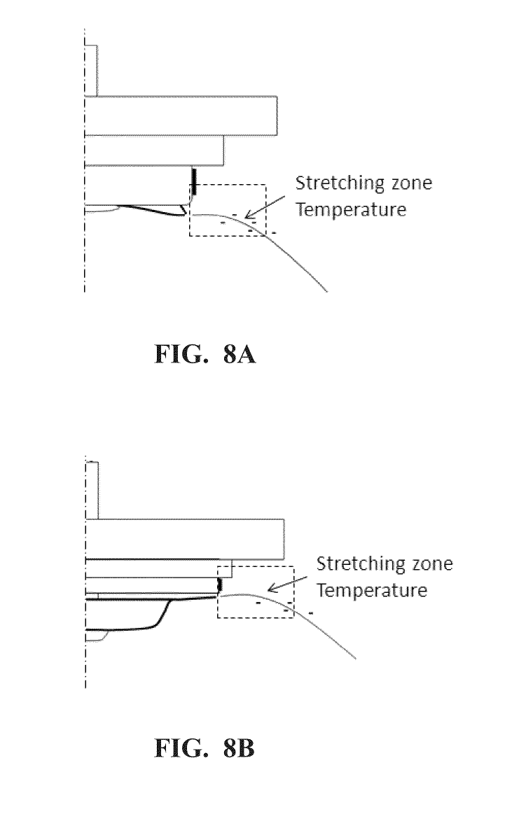

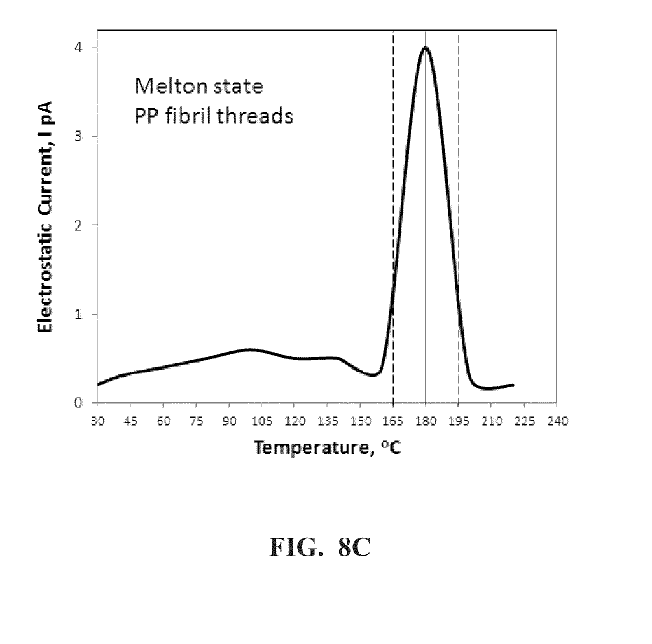

In the case of polymer solution as the process medium, the charging to the solution or nanofiber is not a major issue due to the high electrical conductivity of the solvent. However, in the case of the polymer melt or melt-spun threads, the charging is not easy and trivial because of the low electrical conductivity of most polymers either in the solid or molten state. In the present invention, a stretching zone is defined as the zone of the threads formation around the edge of the rotating spin disk as shown in FIG. 8A, or bowl as shown in FIG. 8B. The temperature of the stretching zone is the key element for keeping the threads in molten state in order to have the fibril threads stretched into nanofibers by centrifugal force. More importantly, there is a temperature regime for polymer melt and fibril threads to take the charging more effectively. FIG. 8C shows the electrostatic current on the molten PP fibril threads as a function of temperature measured by the method of thermally stimulated currents (TSCs). For PP, the temperature regime for polymer melt and fibril threads to take charging more effectively is about 165° C. to 195° C., the best optimal temperature of the stretching zone is 180° C. With charging agents in non-polar polymers, the process will work better.

### Method of Applying Air

The air flow field has two regions in which the direction and rate of air flow are characterized. The first region is a. the point of discharge of fibrils or fibers from the rotating member; the direction of air flow in this first region is essentially perpendicular to the spinning axis of the rotating member. The air flow may be along the radial direction of the rotating member or it may be at an angle to it, the air may be supplied from a plurality of nozzles located proximate to the rotating member or it may be supplied from a slot, or otherwise in a continuous fashion around the edge of the rotating member. The air may be directed radially outwards from the spinning axis, or it may be directed at an angle to the radius at the point where the air leaves any given nozzle.

In one embodiment, the air may therefore be supplied from a nozzle that has an opening that is located on a radius of the rotating member, and the air flow may be directed at an angle to the radius of between 0 and 60 degrees and in a direction opposite to the direction of rotation of the rotating member.

The second region is in the space proximate to the collector and at a distance from the periphery of the rotating member. In this region the air flow is essentially perpendicular to the collector surface. The air therefore directs the fibers on to the surface of the collector where they are pinned by the electrostatic charge on the fibers and the electric field between the collector and the rotating member.

Air in this region may be supplied by nozzles located on the underside of the rotating member, on the surface facing the collector. The nozzles may be directed towards the collector.

The air flow field may further comprise a flow of air into the collector that is essentially perpendicular to the collector from a region between the body of the rotating member and the collector surface.

The present invention is directed toward an electret nanofibrous web comprising a single source randomly intermingled fiber network, wherein the nanofibrous web has an electrostatic charge of at least −8.0 kV, and a web strength of at least 2.0 gf/cm/gsm.

The electret nanofibrous web comprises: (a) at least about 65% by number of fibers in the electret nanofibrous web are nanofibers with a number average diameter less than about 1000 nm; and (b) at most about 30% by number of fibers in the electret nanofibrous web are microfibers with a number average diameter from about 1.0 μm to about 3.0 μm; and (c) at most about 5% by number of fibers in the electret nanofibrous web are coarse fibers with a number average diameter greater than about 3.0 μm. The fibers in the electret nanofibrous web have a number average fiber diameter of less than about 1000 nm. The nanofibers have a mean and median diameter of less than about 500 nm.

The electret nanofibrous web has a porosity of at least about 65%, a mean flow pore size of at most about 15 μm, and a Frazier air permeability from about 10 to about 1000 cm³/cm²/min at 125 Pa. The electret nanofibrous web has a pore size uniformity index of less than about 1.2, and the difference between the mean flow pore and the minimum pore size is less than about 1.5 μm. The electret nanofibrous web has a non-woven flux barrier property of greater than about 0.5.

The electret nanofibrous web has a basis weight of between about 5 to about 100 g/m² or even between about 20 g/m² to about 60 g/m².

The electret nanofibrous web has a ratio of the average strength in the MD (machine direction) and TD (trans machine direction) directions of about 1.0.

The electret nanofibrous web comprises a melt processable thermoplastic polymer. The melt processable thermoplastic polymer can be selected from group consisting of polyolefin and polyester. The polyolefin can be selected from the group consisting of polypropylene, polyethylene and blends thereof. The polyester can be polyethylene terephthalate.

The electret nanofibrous web is made by a centrifugal melt spinning process.

### Test Methods

In the non-limiting Examples that follow, the following test methods were employed to determine various reported characteristics and properties. ASTM refers to the American Society of Testing Materials.

Basis Weight was determined by ASTM D-3776 and report in g/m².

Web Porosity is defined as a ratio of the volumes of the fluid space in a filter divided by the whole volume of the filter, and can be computed from the measured pore volume and bulk density of the material. The porosity of the sample was calculated from the basis weight and the thickness measurement for each sample. In practice, the basis weight (BW) of the sheet is calculated by the weight of a given sample size (W) divided by the sample area (A). The basis weight of the sample sheet was measured by punching out three samples of a fixed area across the transverse direction of the sheet and weighing them using a standard balance. The volume of this sample size is thus A*δ where δ is the thickness of the sample. The thickness was measured using a Checkline MTG-D thickness gauge at a pressure of 10 kPa and was averaged over three measurements at different points of the sample across the transverse direction. The weight of the sample is the weight of the fibers in the sample volume. If the solid fraction of the sheet is φ and the bulk polymer density is ρ, then

W=φρA*δ

Since BW=W/A, Thus φ=BW/ρδ and polymer density ρ

$$\begin{matrix}Porosity = 1 \text{-} Solid Fraction \\ = 1 \text{-} BW / ρδ\end{matrix}$$

Fiber Diameter was measured using scanning electron microscopy (SEM). In order to reveal the fiber morphology in different levels of detail, SEM images were taken at nominal magnifications of ×25, ×100, ×250, ×500, ×1,000, ×2,500, ×5,000 and ×10,000. For fiber diameter counting, fibers were counted from at least 5 (up to 10) images at a magnification of 5000× or 2500×.

Fibers were counted from an image with magnification 500×. At least 400 fibers were individually marked and counted. The area of the 500× image is 36467 micron² while the area of 5 images at 5000× is 1339 micron². In order to ensure the same area for counting at both magnifications, the counts taken at 5000× were multiplied by 36467/1339=27 times. For the individual measurements, a new combined measurement data set was created by replicating the measurements from 5000× magnification 20 times and concatenating that with the measurements from the 500× magnification. If this were not done, there would be bias introduced in the data since the counting at 5000× is more sensitive to smaller fibers and at 500× the counting is more sensitive to larger fibers. Similarly the area of the 2500× image is 1475 micron² so in order to ensure the same area for counting at both magnifications, the counts taken at 2500× were multiplied 4.8 times. For the individual measurements, a new combined measurement data set was created by replicating the measurements from 2500× magnification 5 times and concatenating that with the measurements from the 500× magnification.

Electrostatic Charge (E.S.) is measured using SIMCO FMX-003 Electrostatic Fieldmeter. The FMX-003 measures static voltages within +/−22 kV (22,000V) at a distance of 2.5 cm.

Mean Flow Pore Size was measured according to ASTM E 1294-89, “Standard Test Method for Pore Size Characteristics of Membrane Filters Using Automated Liquid Porosimeter.” Individual samples of different size (8, 20 or 30 mm diameter) were wetted with the low surface tension fluid as described above and placed in a holder, and a differential pressure of air was applied and the fluid removed from the sample. The differential pressure at which wet flow is equal to one-half the dry flow (flow without wetting solvent) is used to calculate the mean flow pore size using supplied software. Mean flow pore size was reported in μm.

Bubble Point was measured according to ASTM F316, “Standard Test Methods for Pore Size Characteristics of Membrane Filters by Bubble Point and Mean Flow Pore Test.” Individual samples (8, 20 or 30 mm diameter) were wetted with the low surface tension fluid as described above. After placing the sample in the holder, differential pressure (air) is applied and the fluid was removed from the sample. The bubble point was the first open pore after the compressed air pressure is applied to the sample sheet and is calculated using vendor supplied software.

Pore Size Uniformity Index (UI) is defined as the ratio of the difference in bubble point diameter and the minimum pore size to the difference in the bubble point and mean flow pore.

$${UI}_{pore} = \frac{BP - Min}{BP - MFP}$$

The closer this ratio is to the value of 2, and then the pore distribution is a Gaussian distribution. If the Uniformity Index is very much larger than 2, the nanofibrous structure is dominated by pores whose diameters are much bigger than the mean flow pore. If the Uniformity Index (UI) much lower than 2, then the more structure is dominated by pores which have pore diameters lower than the mean flow pore diameter. There will still be a significant number of large pores in the tail end of the distribution.

Frazier Air Permeability is a measure of the amount of time required for a certain volume of air to pass through a test specimen. The air pressure is generated by a gravity loaded cylinder that captures an air volume within a chamber using a liquid seal. This pressurized volume of air is directed to the clamping gasket ring, which holds the test specimen. Air that passes through the specimen escapes to atmosphere through holes in the downstream clamping plate. Frazier air permeability measurements were carried out using either a FAP-5390F3 or an FX3300 instrument, both manufactured by Frazier Precision Instrument Co Inc. (Hagerstown, Md.).

In using the FAP-5390F3 instrument, the test specimen is mounted at the sample stand. The pump is so adjusted that the inclined type air pressure gauge shows the pressure of 0.5″ at the water column by use of the resistor for pressure adjustment use. From the scale indication observed then of the vertical type air pressure gauge and the kind of used orifice, the air amount, which passes the test specimen, is obtained. The size of the nozzle was varied depending upon the porosity of the material.

In using the FX3300 instrument, a powerful, muffled vacuum pump draws air through an interchangeable test head with a circular opening. For measurement the test head appropriate for the selected test standard is mounted to the instrument. The specimen is clamped over the test head opening by pressing down the clamping arm which automatically starts the vacuum pump. The preselected test pressure is automatically maintained, and after a few seconds the air permeability of the test specimen is digitally displayed in the pre-selected unit of measure. By pressing down the clamping arm a second time the test specimen is released and the vacuum pump is shut-off. Since the vacuum pump is automatically started when the test specimen is clamped in place over the test head opening, the test pressure builds up only after the test specimen has been clamped. The test pressure is digitally pre-selected in accordance with the test standard. It is automatically controlled and maintained by the instrument. Due to a true differential measurement the test pressure is measured accurately, even at high air flow rates. The air flow through the test specimen is measured with a variable orifice. The air permeability of the test specimen is determined from the pressure drop across this orifice, and is digitally displayed in the selected unit of measure for direct reading. High stability, precision pressure sensors provide for an excellent measuring accuracy and reproducibility of the test results.

In this measurement, a pressure difference of 124.5 N/m² is applied to a suitably clamped media sample and the resultant air flow rate is measured as Frazier air permeability and is reported in units of cm³/min/cm². Frazier air permeability was normalized to 34 g/m² basis weight by multiplying the Frazier air permeability by the basis weight and divided by 34 and is reported in cm³/min/cm². High Frazier air permeability corresponds to high air flow permeability and low Frazier air permeability corresponds to low air flow permeability.

Flux Barrier is a measure of small particle filtration efficiency without sacrificing air or liquid flow. The property is defined as the Frazier Air Permeability m³/m² min divided by the mean flow pore size in microns.

Web Strength was measured from the tensile strength and elongation of nanoweb samples using an INSTRON tensile tester model 1122, according to ASTM D5035-11, “Standard Test Method for Breaking Force and Elongation of Textile Fabrics (Strip Method)” with modified sample dimensions and strain rate. Gauge length of each sample was 5.08 cm with 2.54 cm width. Crosshead speed was 2.54 cm/min (a constant strain rate of 50% min⁻¹). Samples are tested in the “Machine Direction” (MD) as well as in the “Transverse Direction” (TD). A minimum of 3 specimens are tested to obtain the mean value for tensile strength or elongation

### EXAMPLES

In principle, a nanofibrous web media consisting of continuous fibers were made using centrifugal melt spin process of U.S. Pat. No. 8,277,711. Examples in this invention were made by the incorporated with changes of operation on temperatures, melt feeding rate and disk rotating speed in order to create the filming instability, the relative thicker film moves outward with radial banding from the center to the edge, and the film appears wavy in thickness. The nanofibers are formed from the thinner region of thin film, the coarse fibers are from the thick region of the film, and the microfibers are from the film region in between. The process of fiber laying into web media used the process disclosed in WO 2013/096672. The comparative example from commercial materials was used as received unless otherwise indicated.

### Example 1

Continuous fibers were made by a spin bowl using an apparatus as illustrated in FIG. 3, from a low molecular weight (Mw) polypropylene (PP) homopolymer, Metocene MF650Y obtained from LyondellBasell. It has a Mw=75,381 g/mol, melt flow rate=1800 g/10 min (230° C./2.16 kg), and zero shear viscosity of 9.07 Pa·S at 200° C. A PRISM extruder with a gear pump was used to deliver the polymer melt to the rotating spin bowl through the supply tube. The temperature of the spinning melt from the melt supply tube was set to 200° C. the melt feeding rate was 18.14 gram/min. The temperature of spin bowl edge was estimated to be about 200° C. The stretching zone heating air was set at 250° C. The shaping air was set at 150° C. The rotation speed of the spin disk was set to a constant 10,000 rpm. The spin enclosure temperature is 47° C. and the humidity is 11%. The dual high voltage charging was set at +51 kV and 0.25 mA on collector belt, and −7.5 kV and 0.40 mA on the corona ring. The stretching zone air flow was set at 7.0 SCFM. The shaping air flow was set at 15.0 SCFM. The center air flow through the hollow rotating shaft and anti-swirling hub was set at 3.0 SCFM. The nanofiber web was laid down on a belt collector with a laydown distance of 12.7 cm with the belt moving at 43.18 cm/min.

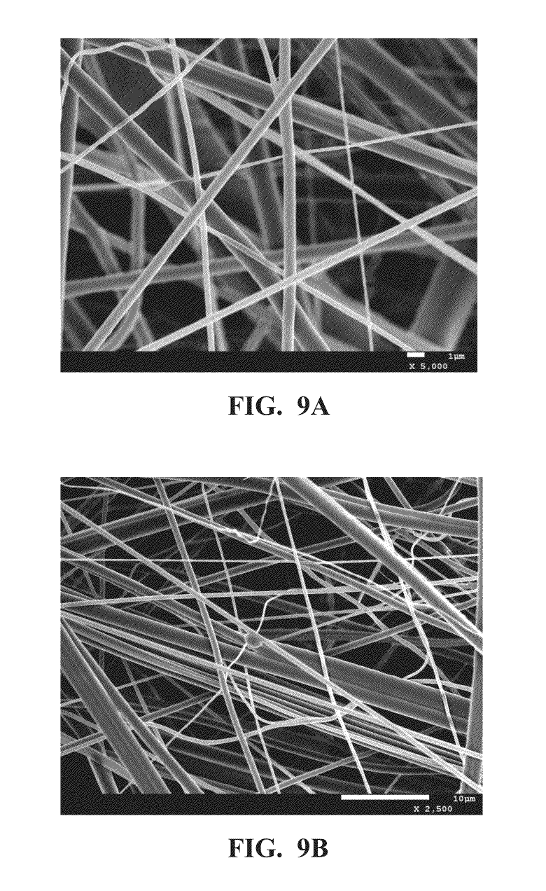

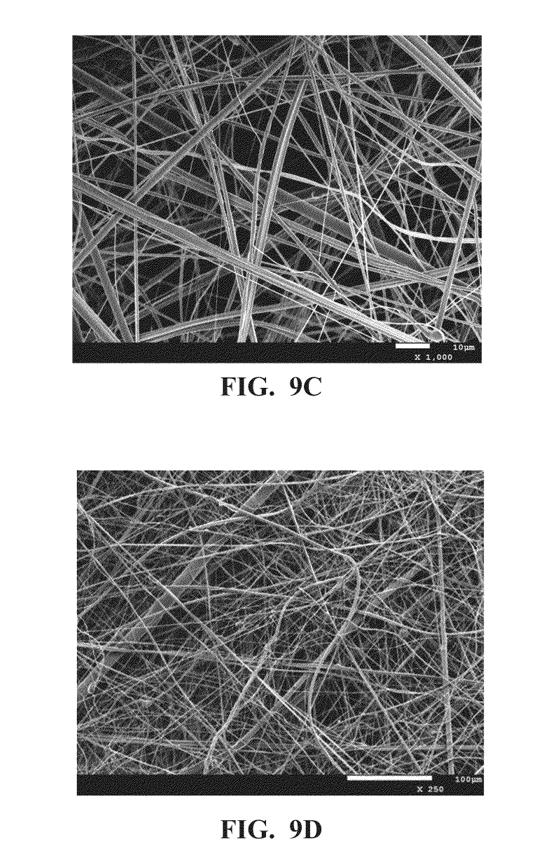

The fiber size was measured from an image using scanning electron microscopy (SEM). FIGS. 9A, 9B, 9C and 9d are SEM images at 5,000×, 2,500×, 1,000× and 250× magnifications. The fibers were determined to have a fiber diameter mean and median for the total fibers measured of 820 and 540 nm, respectively. There are 73.09% nanofibers of the mean=480 nm and the median=420 nm, 26.74% microfibers of the mean=1.74 μm and the median=1.58 μm, 0.17% coarse fibers of the mean=4.92 μm and the median=5.53 μm. The electrostatic charge that remained on the nanofibrous web was −12.6 kV. Other detailed data of web properties are shown in Table 1 and Table 2.

### Example 2

Example 2 was made under the similar condition of Example 1 with the following changes: the temperature of spin bowl edge was estimated about 210° C.; the spin enclosure temperature is 45° C. and the humidity is 12%; the dual high voltage charging is +52 kV and 0.28 mA on collector belt, −7.5 kV and 0.45 mA on the corona ring.

The fiber size was measured from an image using scanning electron microscopy (SEM) and the fibers were determined to have a fiber diameter mean and median for the total fibers measured of 510 and 340 nm, respectively. There are 87.91% nanofibers of the mean=370 nm and the median=310 nm, 11.94% microfibers of the mean=1.48 μm and the median=1.30 μm, 0.15% coarse fibers of the mean=7.09 μm and the median=7.64 μm. The electrostatic charge that remained on the web was −13.8 kV. Other detailed data of web properties are shown in Table 1 and Table 2.

### Example 3

Example 3 was made under the similar condition of Example 1 with the following changes: the temperature of spin bowl edge was estimated to be about 215° C.; the spin enclosure temperature is 41° C. and the humidity is 14%; the dual high voltage charging is +51 kV and 0.23 mA on collector belt, −7.5 kV and 0.44 mA on the corona ring.

The fiber size was measured from an image using scanning electron microscopy (SEM) and the fibers were determined to have a fiber diameter mean and median for the total fibers measured of 500 and 320 nm, respectively. There are 91.06% nanofibers of the mean=350 nm and the median=290 nm, 8.72% microfibers of the mean=2.22 μm and the median=1.62 μm, 0.22% coarse fibers of the mean=6.56 μm and the median=1.92 μm. The electrostatic charge that remained on the web was −12.2 kV. Other detailed data of web properties are shown in Table 1 and Table 2.

### Example 4

Example 4 was made under the similar condition of Example 2 with the following changes: the temperature of spin bowl edge was estimated about 210° C.; the spin enclosure temperature is 44° C. and the humidity is 13%; the dual high voltage charging is +51 kV and 0.25 mA on collector belt, −7.5 kV and 0.42 mA on the corona ring. The nanofibrous web was laid down on a belt collector with a laydown distance of 12.7 cm with the belt moving at 122 cm/min.

The fiber size was measured from an image using scanning electron microscopy (SEM) and the fibers were determined to have a fiber diameter mean and median for the total fibers measured of 510 and 340 nm, respectively. There are 89.31% nanofibers of the mean=350 nm and the median=310 nm, 10.33% microfibers of the mean=1.71 μm and the median=1.65 μm, 0.37% coarse fibers of the mean=5.17 μm and the median=5.09 μm. The electrostatic charge that remained on the web was −11.4 kV. Other detailed data of web properties are shown in Table 1 and Table 2.

### Example 5

Continuous fibers were made by a spin disk using an apparatus as illustrated in FIG. 2, from a low molecular weight (Mw) polypropylene (PP) homopolymer, Metocene MF650W obtained from LyondellBasell. It has a Mw=106.269 g/mol, melt flow rate=500 g/10 min (230° C./2.16 kg), and zero shear viscosity of 38 Pa·S at 200° C. A PRISM extruder with a gear pump was used to deliver the polymer melt to the rotating spin disk through the supply tube. The temperature of the spinning melt from the melt supply tube was set to 200° C. and the melt feeding rate was 8 gram/min. The temperature of spin disk edge was estimated to be about 240° C. The stretching zone heating air was set at 180° C. The shaping air was set at 150° C. The rotation speed of the spin disk was set to a constant 10,000 rpm. There was no charging applied.

The fiber size was measured from an image using scanning electron microscopy (SEM) and the fibers were determined to have a fiber diameter mean and median for the total fibers measured of 820 and 380 nm, respectively. There are 82.29% nanofibers of the mean=390 nm and the median=330 nm, 15.71% microfibers of the mean=2.17 μm and the median=1.88 μm, 2.0% coarse fibers of the mean=7.65 μm and the median=6.39 μm. Other detailed data of web properties are shown in Table 1 and Table 2.

### Example 6

Continuous fibers were made by a spin disk using an apparatus as illustrated in FIG. 2, from a polypropylene (PP) 50%/50% blend of a high Mw PP and a low Mw PP. The high Mw PP was Marlex HGX-350 obtained from Phillips Sumika. It has a Mw=292,079 g/mol, and melt flow rate=35 g/10 min (230° C./2.16 kg). The low Mw PP is Metocene MF650Y used in example 1 was obtained from LyondellBasell. It has a Mw=75,381 g/mol, and melt flow rate=1800 g/10 min (230° C./2.16 kg). The zero shear viscosity of the blend is 131.86 Pa·S at 200° C. A PRISM extruder with a gear pump was used to deliver the polymer melt to the rotating spin disk through the supply tube. The extrusion temperature was set at 240° C. The temperature of the spinning melt from the melt supply tube was set to 290° C. and the melt feeding rate was 10 gram/min. The temperature of the spin disk edge was estimated to be about 260° C. The stretching zone heating air was set at 150° C. The shaping air was set at 80° C. The rotation speed of the spin disk was set at constant 10,000 rpm while the dual high voltage charging was set at +50 kV and 0.07 mA on collector belt, and −12.5 kV and 0.40 mA on the corona ring. The stretching zone air flow was set at 8.0 SCFM. The shaping air flow was set at 12.0 SCFM. The center air flow through the hollow rotating shaft and anti-swirling hub was set at 1.2 SCFM. The nanofiber web was laid down on a belt collector with a laydown distance of 12.7 cm with the belt moving at 35.56 cm/min.

The fiber size was measured from an image using scanning electron microscopy (SEM) and the fibers were determined to have a fiber diameter mean and median for the total fibers measured of 940 and 660 nm, respectively. There are 67.91% nanofibers of the mean=500 nm and the median=480 nm, 28.77% microfibers of the mean=1.60 μm and the median=1.45 μm, 3.32% coarse fibers of the mean=4.05 μm and the median=3.93 μm. The electrostatic charge that remained on the web was −12.9 kV. Other detailed data of web properties are shown in Table 1 and Table 2.

### Example 7

Continuous fibers were made by a spin disk using an apparatus as illustrated in FIG. 2, from a polyethylene terephthalate (PET) homopolymer, PET F53, obtained from Eastman Chemical. The melting point of this polymer is 265° C. and the resin has IV of 0.53. The zero shear viscosity of the blend is 61.3 Pa·S at 270° C. A PRISM extruder with a gear pump was used to deliver the polymer melt to the rotating spin disk through the supply tube. The extrusion temperature was set at 280° C. The temperature of the spinning melt from the melt supply tube was set at 290° C. and the melt feeding rate was 10 gram/min. The temperature of spin disk edge was estimated to be about 300° C. The stretching zone heating air was set at 80° C. The shaping air was set at 30° C. The rotation speed of the spin disk was set at constant 10,000 rpm. The dual high voltage charging was set at +50 kV and 0.02 mA on collector belt, and 0.0 kV and 0.00 mA on the corona ring. The stretching zone air flow was set at 8.0 SCFM. The shaping air flow was set at 12.0 SCFM. The center air flow through the hollow rotating shaft and anti-swirling hub was set at 1.25 SCFM. The nanofiber web was laid down on a belt collector with a laydown distance of 12.7 cm with the belt moving at 22.5 cm/min.

The fiber size was measured from an image using scanning electron microscopy (SEM) and the fibers were determined to have a fiber diameter mean and median for the total fibers measured of 680 and 560 nm, respectively. There are 78.26% nanofibers of the mean=460 nm and the median=400 nm, 21.6% microfibers of the mean=1.56 μm and the median=1.21 μm, 0.14% coarse fibers of the mean=5.34 μm and the median=4.75 μm. The electrostatic charge that remained on the web was −8.8 kV. Other detailed data of web properties are shown in Table 1 and Table 2.

### Example 8

Continuous fibers were made by a spin disk using an apparatus as illustrated in FIG. 2, from a polyethylene terephthalate (PET) homopolymer, PET F61, obtained from Eastman Chemical. The melting point of this polymer is 265° C. and the resin has IV of 0.61. The zero shear viscosity of the blend is 163.38 Pa·S at 270° C. A PRISM extruder with a gear pump was used to deliver the polymer melt to the rotating spin disk through the supply tube. The extrusion temperature was set at 285° C. The temperature of the spinning melt from the melt supply tube was set at 308° C. and the melt feeding rate was 10 gram/min. The temperature of spin disk edge was estimated to be about 300° C. The stretching zone heating air was set at 60° C. The shaping air was set at 25° C. The rotation speed of the spin disk was set at constant 10,000 rpm. The dual high voltage charging was set at +50 kV and 0.00 mA on collector belt, and 0.0 kV and 0.00 mA on the corona ring. The stretching zone air flow was set at 8.0 SCFM. The shaping air flow was set at 12.0 SCFM. The center air flow through the hollow rotating shaft and anti-swirling hub was set at 2.0 SCFM. The nanofiber web was laid down on a belt collector with a laydown distance of 12.7 cm with the belt moving at 18 cm/min.

The fiber size was measured from an image using scanning electron microscopy (SEM) and the fibers were determined to have a fiber diameter mean and median for the for the total fibers of 760 nm and 530 nm, respectively. There are 76.14% nanofibers of the mean=480 nm and the median=420 nm, 23.8% microfibers of the mean=1.67 μm and the median=1.44 μm, 0.05% coarse fibers of the mean=6.14 μm and the median=6.14 μm. The electrostatic charge that remained on the web was −12.8 kV. Other detailed data of web properties are shown in Table 1 and Table 2.

### Example 9

Example 9 was spun under the same condition of Example 1 followed by post-processes after 8 months. The as-spun web roll was calendered at room temperature and 800 psi by Cotton/Steel rolls with zero gap. The fiber diameters remained the same as Example 1. The electrostatic charge that remained on the web was −3.2 kV after roll-to-roll post-process. Other detailed data of web properties are shown in Table 1 and Table 2.

### Comparative Example 1

Continuous fibers were made by a spin disk using an apparatus as illustrated in FIG. 2, from a low molecular weight (Mw) polypropylene (PP) homopolymer, Metocene MF650Y obtained from LyondellBasell. It has a Mw=75,381 g/mol, melt flow rate=1800 g/10 min (230° C./2.16 kg), and zero shear viscosity of 9.07 Pa·S at 200° C. A PRISM extruder with a gear pump was used to deliver the polymer melt to the rotating spin disk through the supply tube. The temperature of the spinning melt from the melt supply tube was set at 210° C. and the melt feeding rate was 10 gram/min. The temperature of spin disk edge was estimated to be about 260° C. The stretching zone heating air was set at 150° C. The shaping air was set at 150° C. The rotation speed of the spin disk was set at constant 14,000 rpm. No charging was applied.

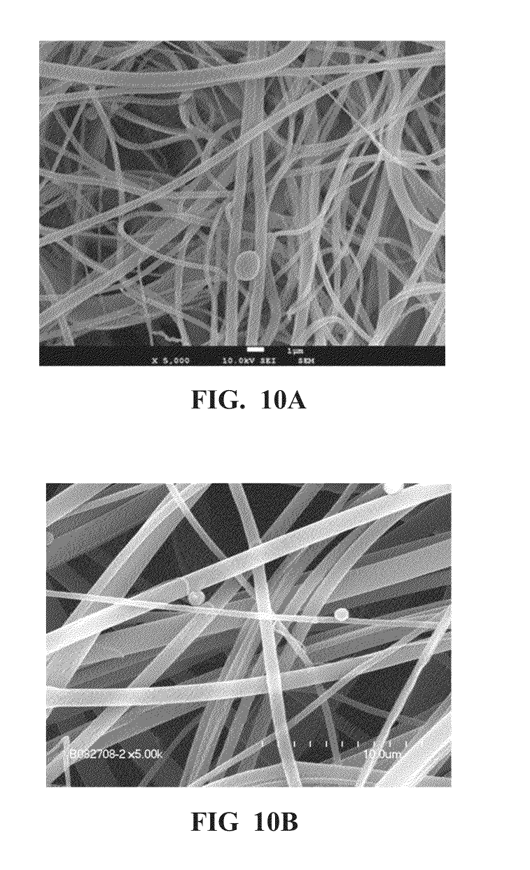

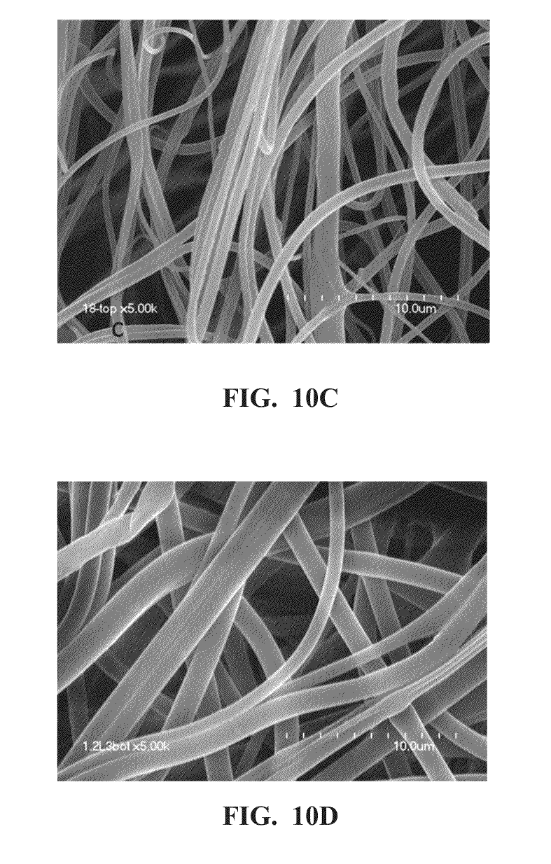

The fiber size was measured from an image using scanning electron microscopy (SEM). An SEM image is shown in FIG. 10A, and the fibers were determined to have a fiber diameter mean and median for the total fibers measured of 430 and 380 nm, respectively. There are nearly 100% nanofibers. Other detailed data of web properties are shown in Table 1 and Table 2.

### Comparative Example 2

Continuous fibers were made by film blowing using an apparatus as illustrated in FIG. 7, from a low molecular weight (Mw) polypropylene (PP) homopolymer, GPH1400M obtained from LyondellBasell. It has a melt flow rate=2300 g/10 min (230° C./2.16 kg), and zero shear viscosity of 5.3 Pa·S at 200° C. A PRISM extruder with a gear pump was used to deliver the polymer melt to the filming blade through a coat-hanger die and a pair of blowing air knives. The temperature of the spinning melt from the melt supply tube was set at 210° C. and the melt feeding rate was 10 gram/min. The temperature of filming blade edge was estimated to be about 260° C. The blowing air was set at 250° C. No charging was applied. The die to collector distance was 22 cm. The collector speed was 3.8 m/min.

The fiber size was measured from an image using scanning electron microscopy (SEM). An SEM image is shown in FIG. 10B, and the fibers were determined to have a fiber diameter mean and median for the total fibers measured of 1.04 μm and 0.84 μm, respectively. There are 56.19% nanofibers of the mean=540 nm and the median=500 nm, 42.67% microfibers of the mean=1.60 μm and the median=1.39 μm, 1.13% coarse fibers of the mean=5.07 μm and the median=5.96 μm. Other detailed data of web properties are shown in Table 1 and Table 2.

### Comparative Example 3

Comparative Example 3 was made from a low molecular weight (Mw) polypropylene (PP) homopolymer, Metocene MF650Y obtained from LyondellBasell. It has a Mw=75,381 g/mol, melt flow rate=1800 g/10 min (230° C./2.16 kg), and the zero shear viscosity of 9.07 Pa·S at 200° C. The spinning technology used to produce the comparative sample was that developed by Nonwovens Technology Incorporated and manufactured by the Arthur G. Russell Company. The sample was provided by Nonwovens Research Lab at The University of Tennessee. The process conditions were not available.

The fiber size was measured from an image using scanning electron microscopy (SEM). An SEM image is shown in FIG. 10C, and the fibers were determined to have a fiber diameter mean and median for the total fibers measured of 560 nm and 450 nm, respectively. There are 92.6% nanofibers of the mean=470 nm and the median=438 nm, 7.4% microfibers of the mean=1.58 μm and the median=1.38 μm, there were no coarse fibers. Other detailed data of web properties are shown in Table 1 and Table 2.

### Comparative Example 4

Comparative Example 4 was polypropylene melt blown media from Cuno commercial filter. The process conditions were not available. The fiber size was measured from an image using scanning electron microscopy (SEM). An SEM image is shown in FIG. 10D, and the fibers were determined to have a fiber diameter mean and median for the total fibers of 1.44 μm and 1.32 μm, respectively. There are 23.91% nanofibers of the mean=770 nm and the median=830 nm, 76.09% microfibers of the mean=1.65 μm and the median=1.45 μm, there were no coarse fibers. Other detailed data of web properties are shown in Table 1 and Table 2.

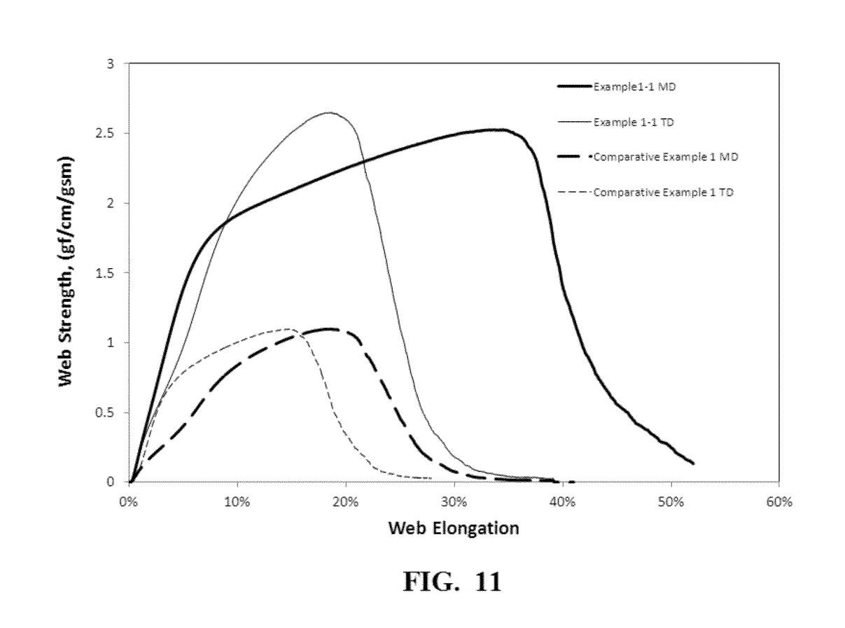

The single layer coarse-grade nanofibrous web can be made by a nozzle-less centrifugal melt spinning process of U.S. Pat. No. 8,277,711 with modified operation conditions as described above and the resulting nanofibers can be laid on a belt collector to form web media using the process of WO 2013/096672. The single layer coarse-grade nanofibrous web comprising intermingled fiber networks of the majority of nanofibers, the small percentage of microfibers and some of coarse fibers can be made through the single process as a single source. The resulting nanofibrous web has a number average fiber diameter of total fibers about and less than 1000 nm. There are at least 65% nanofibers with the mean and median diameter less than 500 nm. The at most 35% microfibers and the rest of coarse fibers. The optimized electrostatic charging used in helping fiber laydown into nonwoven web makes the resulting web an electrets. The electrostatics in the web is about at least −8.0 kV, and it was remained at least −3.0 kV in the web even after roll-to-roll post-processes in 8 months after spinning, such as, triming, rewinding and calendering, as shown as in Example 9. The web strength was good for the roll-to-roll post-processes. The microfibers and the coarse fibers contribute to the web strength. The mechanical strength of nanofibrous web in the present invention is greater than the pure nanofiber web of Comparative Example 1, as shown in FIG. 11. The ratio of the average strength in MD and TD directions is about 1.0. The similar web structure can be made by the film blowing process as shown as in FIG. 7. The resulting web has shown as Comparative Example 2. The film blowing process can only process very low viscosity polymers, and the mechanical strength of resulting webs was usually much lower than the nanofibrous web in the present invention.

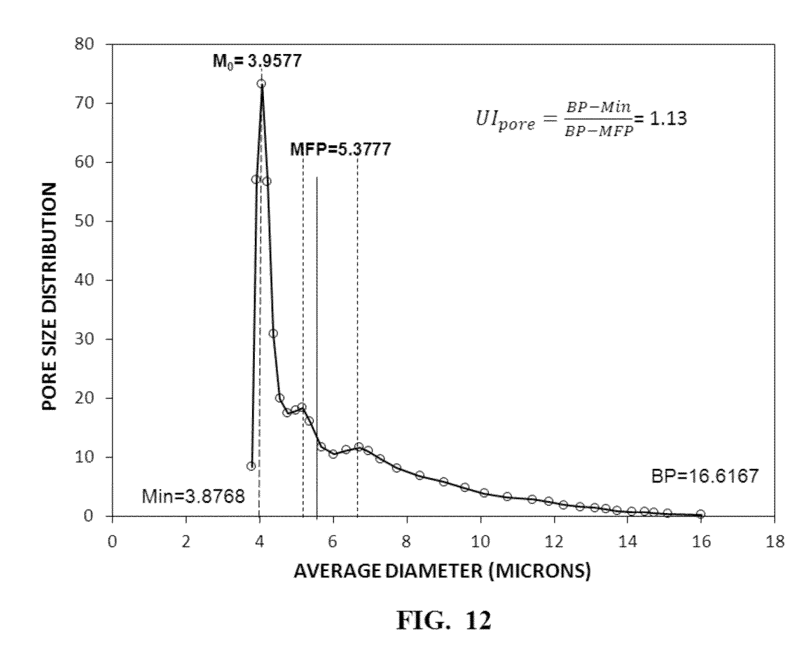

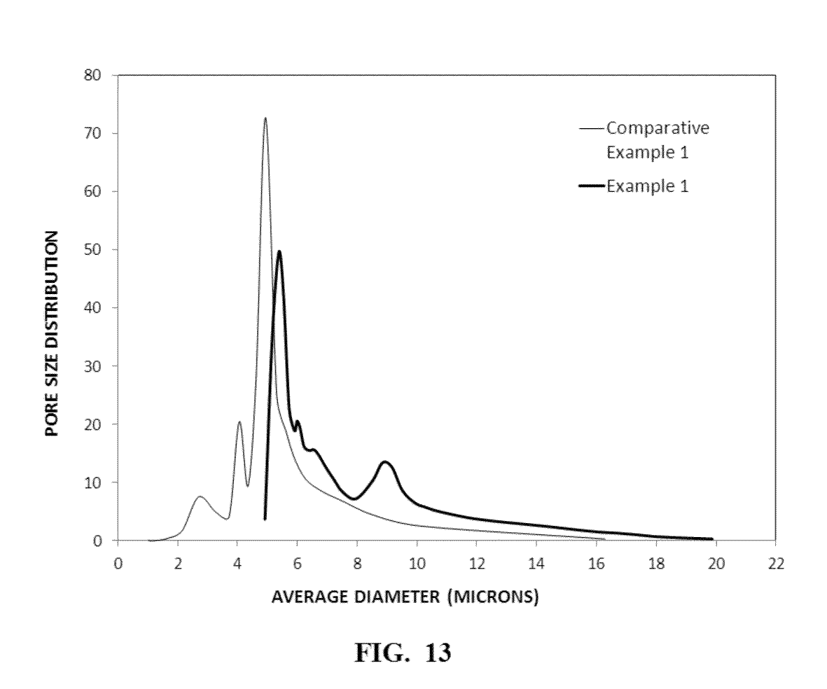

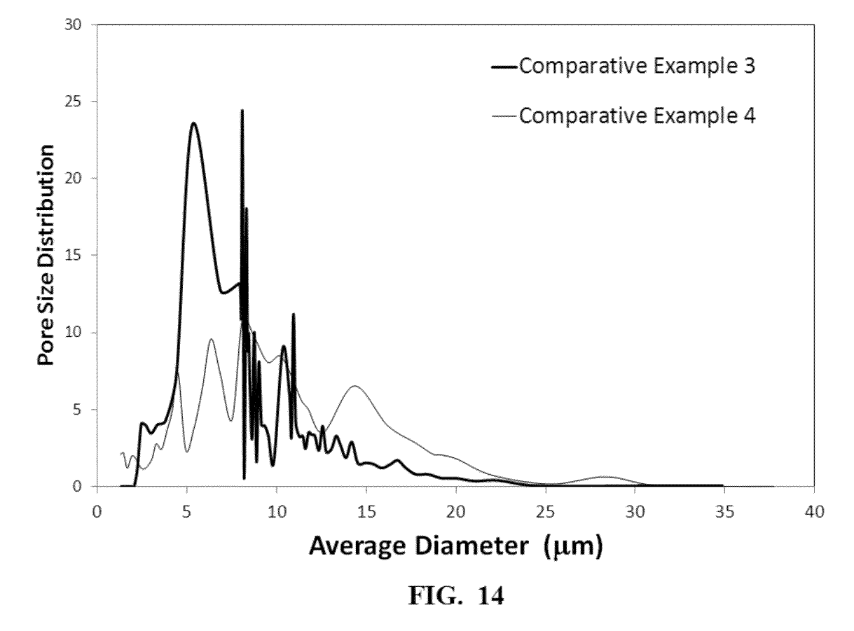

The unique pore structure of nanofibrous web of the present invention has shown in FIG. 12, where the difference between the mean flow pore and the minimum pore size is less than 1.5. The uniformity of the pore structure of nanofibrous web in the present invention is better than all Comparative Examples, as shown as FIG. 13, in the comparison with the pure nanofiber web of Comparative Example 1, and FIG. 14, in the comparison with the meltblown nanofiber web of Comparative Example 3 and with the meltblown microfiber web of Comparative Example 4. The pore size uniformity index of the pore structure of nanofibrous web in the present invention is less than 1.2, and comparing with bigger than 1.2 for all Comparative Examples.

TABLE 1
Fiber Size

| | Total Fibers | | Nanofibers | | | Microfibers | | | Coarse Fibers | | |
|---|---|---|---|---|---|---|---|---|---|---|---|
| | Mean | Median | Mean | Median | Number | Mean | Median | Number | Mean | Median | Number |
| Example ID | (μm) | (μm) | (μm) | (μm) | Percentage | (μm) | (μm) | Percentage | (μm) | (μm) | Percentage |
| Example 1 | 0.82 | 0.54 | 0.48 | 0.42 | 73.09% | 1.74 | 1.58 | 26.74% | 4.92 | 5.53 | 0.17% |
| Example 2 | 0.51 | 0.34 | 0.37 | 0.31 | 87.91% | 1.48 | 1.3 | 11.94% | 7.09 | 7.64 | 0.15% |
| Example 3 | 0.5 | 0.32 | 0.35 | 0.29 | 91.06% | 2.22 | 1.62 | 8.72% | 6.56 | 1.92 | 0.22% |
| Example 4 | 0.51 | 0.34 | 0.35 | 0.31 | 89.31% | 1.71 | 1.65 | 10.33% | 5.17 | 5.09 | 0.37% |
| Example 5 | 0.82 | 0.38 | 0.39 | 0.33 | 82.29% | 2.17 | 1.88 | 15.71 | 7.65 | 6.39 | 2.00% |
| Example 6 | 0.94 | 0.66 | 0.5 | 0.48 | 67.91% | 1.6 | 1.45 | 28.77% | 4.05 | 3.93 | 3.32% |
| Example 7 | 0.68 | 0.56 | 0.46 | 0.4 | 78.26% | 1.56 | 1.21 | 21.60% | 5.34 | 4.75 | 0.14% |
| Example 8 | 0.76 | 0.53 | 0.48 | 0.42 | 76.14% | 1.67 | 1.44 | 23.80% | 6.14 | 6.14 | 0.05% |
| Comparative | 0.43 | 0.38 | 0.43 | 0.38 | 100% | | | | | | |
| Example 1 | | | | | | | | | | | |
| Comparative | 1.04 | 0.84 | 0.54 | 0.5 | 56.19% | 1.6 | 1.39 | 42.67% | 5.07 | 5.96 | 1.13% |
| Example 2 | | | | | | | | | | | |
| Comparative | 0.82 | 0.54 | 0.48 | 0.42 | 73.09% | 1.74 | 1.58 | 26.74% | 4.92 | 5.53 | 0.17% |
| Example 3 | | | | | | | | | | | |
| Comparative | 0.56 | 0.45 | 0.47 | 0.438 | 92.60% | 1.58 | 1.38 | 7.40% | | | |
| Example 4 | | | | | | | | | | | |
| Comparative | 1.44 | 1.32 | 0.77 | 0.83 | 23.91% | 1.65 | 1.45 | 76.09% | | | |
| Example 5 | | | | | | | | | | | |

TABLE 2
Media Properties

| | | | | | | | UI = | | | | | | | |
|---|---|---|---|---|---|---|---|---|---|---|---|---|---|---|
| | | Zero | | | | | (BP − | | | | | | | |
| | | Shear | | | | | Min)/ | | Thick- | Frazier | | E.S. | Avg. MD/TD | |
| | | Viscosity | MFP | Min | BP | MFP − | (BP − | BW | ness | (cm³/cm²/ | Porosity | Charge | Strength | Flux |
| | Polymer | (Pa · S) | (μm) | (μm) | (μm) | Min | MFP) | (gsm) | (μm) | min) | (%) | (kV) | (gf/cm/gsm) | Barrier |
| Example 1 | PP | 9.07 | 6.16 | 5.04 | 19.86 | 1.12 | 1.01 | 60 | 381 | 356.6 | 83.42 | −12.6 | 2.55/2.61 | 0.50 |
| | | @200° C. | | | | | | | | | | | | |
| Example 2 | PP | 9.07 | 5.38 | 3.88 | 16.62 | 1.5 | 1.13 | 60 | 498.4 | 323.1 | 86.7 | −13.8 | 2.38/2.59 | 0.60 |
| | | @200° C. | | | | | | | | | | | | |
| Example 3 | PP | 9.07 | 6.19 | 5.39 | 18.96 | 0.8 | 1.06 | 42.9 | 335.26 | 509.0 | 86.53 | −12.2 | 2.35/2.93 | 0.76 |
| | | @200° C. | | | | | | | | | | | | |
| Example 4 | PP | 9.07 | 6.57 | 6.05 | 22.91 | 0.52 | 1.03 | 20 | 157.48 | 871.7 | 86.63 | −11.4 | 2.45/2.98 | 1.33 |
| | | @200° C. | | | | | | | | | | | | |
| Example 5 | PP | 38 | 7.58 | 6.96 | 28.19 | 0.62 | 1.03 | 36 | 206 | 475.5 | 81.6 | NO | 3.59/4.21 | 0.63 |
| | | @200° C. | | | | | | | | | | | | |
| Example 6 | PP | 131.86 | 4.3 | 3.62 | 10.9 | 0.68 | 1.1 | 46 | 154.94 | 185.9 | 68.75 | −12.9 | 4.21/3.97 | 0.43 |
| | blend | @200° C. | | | | | | | | | | | | |
| Example 7 | PET | 61.3 | 5.45 | 4.24 | 23.19 | 1.21 | 1.07 | 27 | 103.6 | 798.6 | 81.11 | −8.8 | 4.34/4.14 | 1.47 |
| | | @270° C. | | | | | | | | | | | | |
| Example 8 | PET | 163.38 | 5.3 | 3.89 | 19.12 | 1.41 | 1.11 | 15 | 63.5 | 920.5 | 82.88 | −12.8 | 5.45/5.68 | 1.70 |
| | | @270° C. | | | | | | | | | | | | |
| Example 9 | PP | 9.07 | 1.48 | 0.95 | 4.55 | 0.77 | 1.17 | 60 | 105 | 16.5 | 39.85 | −3.2 | 7.33/6.83 | 0.11 |
| | | @200° C. | | | | | | | | | | | | |
| Comparative | PP | 9.07 | 5.08 | 1.024 | 16.28 | 4.056 | 1.35 | 30 | 204 | 1408.2 | 84.52 | NO | 1.14/1.09 | 2.77 |
| Example 1 | | @200° C. | | | | | | | | | | | | |
| Comparative | PP | 5.3 | 5.48 | 1.45 | 24.38 | 4.03 | 1.21 | 21.1 | 191.8 | 1258.8 | 88.42 | NO | 0.56/0.34 | 2.30 |
| Example 2 | | @200° C. | | | | | | | | | | | | |
| Comparative | PP | 9.07 | 6.1 | 1.47 | 34.42 | 4.63 | 1.35 | 18.7 | 186.5 | 1551.4 | 89 | NO | 2.29/0.58 | 2.54 |
| Example 3 | | @200° C. | | | | | | | | | | | | |
| Comparative | PP | N/A | 9.7 | 1.63 | 37.74 | 8.07 | 1.39 | 50 | 212.9 | 253.0 | 75.28 | NO | 7.47/5.29 | 0.26 |
| Example 4 | | | | | | | | | | | | | | |

What is claimed is:

1. A electret nanofibrous web comprising a single source randomly intermingled fiber network, wherein the electret nanofibrous web has an electrostatic charge of at least −8.0 kV, and a web strength of at least 2.0 gf/cm/gsm.

2. The electret nanofibrous web of claim 1, wherein the electret nanofibrous web comprises:
(a) at least about 65% by number of fibers in the electret nanofibrous web are nanofibers with a number average diameter less than about 1000 nm; and
(b) at most about 30% by number of fibers in the electret nanofibrous web are microfibers with a number average diameter from about 1.0 μm to about 3.0 μm; and
(c) at most about 5% by number of fibers in the electret nanofibrous web are coarse fibers with a number average diameter greater than about 3.0 μm.

3. The electret nanofibrous web of claim 2, wherein the fibers in the electret nanofibrous web have a number average fiber diameter of less than about 1000 nm.

4. The electret nanofibrous web of claim 2, wherein the nanofibers have a mean and median diameter of less than about 500 nm.

5. The electret nanofibrous web of claim 1, wherein the electret nanofibrous web has a porosity of at least about 65%, a mean flow pore size of at most about 15 μm, and a Frazier air permeability from about 10 to about 1000 cm³/cm²/min at 125 Pa.

6. The electret nanofibrous web of claim 1, wherein the electret nanofibrous web has a pore size uniformity index of less than about 1.2, and the difference between the mean flow pore and the minimum pore size is less than about 1.5 μm.

7. The electret nanofibrous web of claim 1, wherein the electret nanofibrous web has a non-woven flux barrier property of greater than about 0.5.

8. The electret nanofibrous web of claim 1, wherein the electret nanofibrous web has a basis weight of between about 5 to about 100 g/m².

9. The electret nanofibrous web of claim 8, wherein the electret nanofibrous web has a basis weight of between about 20 g/m² to about 60 g/m².

10. The electret nanofibrous web of claim 1, the electret nanofibrous web has a ratio of the average strength in the MD and TD directions of about 1.0.

11. The electret nanofibrous web of claim 1, wherein the electret nanofibrous web comprises a melt processable thermoplastic polymer.

12. The electret nanofibrous web of claim 11, wherein the melt processable thermoplastic polymer is selected from the group consisting of polyolefin and polyester.

13. The electret nanofibrous web of claim 12, wherein the polyolefin is selected from the group consisting of polypropylene, polyethylene and blends thereof.

14. The electret nanofibrous web of claim 12, wherein the polyester is polyethylene terephthalate.

15. The electret nanofibrous web of claim 1, wherein the electret nanofibrous web is made by a centrifugal melt spinning process.
